(19) United States
(12) Patent Application Publication
(10) Pub. No.: US 2023/0331601 A1
(43) Pub. Date: Oct. 19, 2023

(54) METHOD FOR WATER PURIFICATION AND SANITIZATION

(71) Applicant: YISSUM RESEARCH DEVELOPMENT COMPANY OF THE HEBREW UNIVERSITY OF JERUSALEM LTD., Jerusalem (IL)

(72) Inventors: Yoel SASSON, Tel Aviv (IL); Uri STOIN, Jerusalem (IL)

(21) Appl. No.: 17/998,686

(22) PCT Filed: May 13, 2021
(86) PCT No.: PCT/IL2021/050551

§ 371 Date: Nov. 14, 2022

Related U.S. Application Data
(60) Provisional application No. 63/026,053, filed on May 17, 2020.

(51) Int. Cl. C02F 1/72; C02F 1/66

(52) U.S. Cl. CPC C02F 1/722; C02F 1/66; C02F 1/727; C02F 2101/36; C02F 2305/04

(57) ABSTRACT

A method of purifying water polluted with one or more organic compounds, includes adding a peroxide source to the polluted water in an alkaline environment in the presence of at least one additive selected from the group consisting of surfactants and phase transfer catalysts, optionally feeding oxygen or an oxygen-releasing substance to the water, separating the so-formed reaction mixture into aqueous and organic phases, to recover a treated water stream by an organic stream, wherein the purification of the water by the removal of organic pollutants is achieved at ambient temperature. The method can also be used for disinfection of water polluted with microbial pollutants.

### CROSS-REFERENCE TO RELATED APPLICATIONS

This application is a National Stage application of International Patent Application No. PCT/IL2021/050551, filed on May 13, 2021, which claims priority to U.S. Provisional Pat. Application No. 63/026,053, filed May 17, 2020, each of which is hereby incorporated by reference in its entirety.

### TECHNICAL FIELD

This application relates to water purification and, more specifically, to a method for water purification and sanitization.

### Background

Advanced oxidation processes (AOP) are increasingly gaining interest owing to technical and environmental benefits they offer in connection with water treatment. In its most general form, AOP is designed to generate strong oxidizing species, for example, the hydroxyl radical, to decompose pollutants.

Various protocols of AOPs based on hydrogen peroxide are known, with a significant body of literature focusing on the combination of hydrogen peroxide and iron. That is, chemical oxidation of organic pollutants by the Fenton reaction, as described for example in WO 2013/132294.

However, relatively little has been reported about the combined action of hydrogen peroxide and alkali hydroxide for treating polluted water to eliminate chemical and microbial pollutants. The aqueous reagent formed when hydrogen peroxide is mixed with highly concentrated solution of alkali hydroxide has been shown to decompose polyhalogen compounds (WO 2013/093903 and Stoin, U. et al. ChemPhysChem, 2013, 14, 4158) and petroleum products in contaminated soil (WO 2015/170317). It has been demonstrated in the aforementioned publications that under specific conditions, e.g., an exceptionally high alkaline environment, the superoxide radical anion (02-•) that is generated in the H₂O₂+MOH mixture (M indicates the alkali metal) is sufficiently stable to accomplish oxidation of organic pollutants in soil. That is, soil remediation can be successfully achieved by means of injection of aqueous solutions of alkali hydroxide and hydrogen peroxide to soil.

As to the treatment of water streams or water bodies which are contaminated with chemical pollutants, it has been shown in GB 1,526,190 that nitrogen-containing compounds could be removed from certain waste streams upon addition of hydrogen peroxide and sodium hydroxide at elevated temperatures. CN 101830580 deals with treatment of glyphosate mother solution, reporting oxidation of phosphorous and nitrogen-containing impurities with the aid of a combination of alkali hydroxide and hydrogen peroxide.

Another kind of water pollution is by microbial pollutants; microbial pollution of water constitutes a serious problem in many countries. Chlorination is the most common method currently employed for water disinfection.

### SUMMARY

We have now found that water purification (removal of chemical organic pollutants from water, e.g., by their mineralization) or water disinfection (inactivation of microbial pollutants and possibly also their decomposition) can be achieved by the combined action of a strong base, in particular alkali hydroxide, and a peroxide compound, in particular hydrogen peroxide, in the presence of additives selected from the group consisting of surface active agents and phase transfer catalysts, preferably with the aid of added oxygen or a source able to supply or release oxygen in the water body to be treated. The purification or disinfection treatment preferably takes place at ambient temperature, e.g., at a temperature below 30° C. (e.g., from 15° C. to 25° C.) .

Regarding water purification, it should be noted that treatment of water to eliminate organic pollutants devoid of a heteroatom (e.g., nitrogen) generally meets with great difficulties. That is, compounds composed of carbon, hydrogen and halogen atoms are in general more difficult to decompose by oxidation compared to nitrogen-containing compounds. However, the experimental results reported below indicate that the invention enables decontamination of water polluted with a wide range of pollutants, for example:
aromatic compounds (e.g., benzene and alkyl-substituted benzene such as toluene and xylene, polycyclic aromatic hydrocarbons compounds consisting of two or more aromatic rings fused together such as naphthalene, and halogenated aromatic rings such as chlorobenzene); and
halogen-substituted aliphatic hydrocarbons, e.g., halogenated C1-C2 alkanes and alkenes (especially halogenated methane, ethane and ethylene compounds, including mixed halogen-substituted compounds, e.g., chlorinated/brominated).

The experimental results reported below also demonstrate the utility of the invention in disinfecting water contaminated with E.coli, suggesting that other microbial pollutants prone to undergo inactivation in the presence of hydroxyl or superoxide radicals can be killed by the method of the invention. In fact the potential of the H₂O₂+MOH reagent aided by a surface active agent or a phase transfer catalyst manifests itself in both bactericidal activity (reduction of the number of viable cells which form colonies on nutrient agar plates) and decomposition activity (oxidation of the carbon content of the bacteria to carbon dioxide). Stated otherwise, “water disinfection” according to the invention is meant to include (i) inactivation of viable microorganisms or (ii) both inactivation of viable microorganisms and destruction of at least a portion of their cells. The former effect is measured in terms of colony forming units (CFU/ml) using conventional techniques. The latter effect is indicated by evolution of carbon dioxide following the oxidation of carbon from the bacteria. As shown in the experimental section below, CO₂ generation in the treated water may be detected in different ways to confirm the decomposition of the cells.

Alternatively, destruction of specific constituents of the cell wall of the bacteria may be determined.

Accordingly, a first aspect of the invention is a method of purifying water polluted with one or more organic compounds, in particular compounds devoid of nitrogen and phosphorous atoms, said method comprising adding a peroxide source (e.g., hydrogen peroxide) to the polluted water in an alkaline environment in the presence of at least one additive selected from the group consisting of surfactants and phase transfer catalysts, optionally feeding oxygen or an oxygen-releasing substance to the water, optionally holding the resultant reaction mixture under stirring, separating the reaction mixture into aqueous and organic phases, to recover a treated water stream and an optionally recyclable organic stream. The method is carried out at ambient temperature and preferably at normal pressure. For example, aromatic hydrocarbon(s) and/or organohalogen compound(s) is (are) removed from the water.

A second aspect of the invention is a method of disinfecting water polluted with microbial pollutants, e.g., bacteria, comprising adding a peroxide source (e.g., hydrogen peroxide) to the polluted water in an alkaline environment in the presence of at least one additive selected from the group consisting of surfactants and phase transfer catalysts, optionally feeding oxygen or an oxygen-releasing substance to the water, optionally holding the resultant reaction mixture under stirring, separating the reaction mixture into aqueous and organic phases, to recover treated water stream and an optionally recyclable organic stream. The method takes place at ambient temperature and preferably at normal pressure.

An illustrative design of the process is shown in FIG. 1. Polluted water stream (1), for example, an outflow aqueous stream discharged from an industrial chemical plant, is fed by means of pump (2) into a reactor (3), e.g., a stirred-tank reactor which can be operated in batch, semi-batch or continuous mode. Heat can be added to, or removed from, the reactor via external jackets or internals coils (not shown). However, the treatment is advanced effectively without supply of heat. Reagent feed streams, which are collectively indicated by numeral (5), include peroxide source (5a), alkali hydroxide (5b), an organic additive (5c) and oxygen gas (5d). Removal of gases evolving in the reactor is through gas outlet (4).

The preferred peroxide source (5a) is an industrial strength hydrogen peroxide solution, e.g., 5-70% w/w. Other inorganic peroxides such as calcium peroxide which are available in the market in a solid, e.g., granular form, can also be used.

The alkali hydroxide (5b), e.g., sodium hydroxide or potassium hydroxide, can be employed either in a solid form or as an aqueous solution containing from 5% to 50% by weight alkali hydroxide.

The organic additive (5c) seems to play an important role in enabling the reaction between the pollutant present in the water and the oxidizing species formed in-situ when hydrogen peroxide is mixed with alkali hydroxide. The organic additives fall into two groups. The first group of organic additives consists of surfactants, in particular anionic surfactants and nonionic surfactants. Preferred anionic surfactants include salts of long-chain carboxylic acid, e.g., with C₁₀-C₂₀ chains, especially the sodium or potassium salt of said acids, in particular salts of fatty acids, namely, soaps. Soap solution is an especially preferred additive. Other types of anionic surfactants include, for example, sulfates, such as alkyl sulfates (e.g., sodium or ammonium dodecyl sulfate). Preferred nonionic surfactants include compounds with polyethylene glycol chain, specifically polyoxyethylene fatty acid esters, such as polyoxyethylene sorbitan monooleate (tween® 80) and polyoxyethylene sorbitan monostearate (tween® 60); glycerol esters; nonionic soaps and glucosides.

The second group of organic additives consists of phase transfer catalysts, e.g., salts having nitrogen-containing cation, e.g., a quaternary ammonium cation, namely, N⁺R₁R₂R₃R₄ wherein each of R₁, R₂, R₃ and R₄ is independently C1-C18 alkyl group (preferably C1-C12 alkyl, which may be either linear or branched, most preferably linear) and a counter anion, e.g., halide anion such as chloride or bromide. Preferred are quaternary ammonium salts of the formula N⁺CH₃[(CH₂)ₖCH₃]₃Ha1⁻, wherein k is at least 5, e.g., between 5 to 9, and Hal is chloride or bromide. As an example of this preferred sub-class of quaternary ammonium salts, methyltrioctyl ammonium halide can be mentioned (k=7), which is commercially available in the form of its chloride salt as Aliquat 336. Ionic liquids where the nitrogen-containing cation consists of a nitrogen-containing ring, such as 1-alkyl-3-methylimidazolium halide salt, for example, 1-butyl-3-methylimidazolium halide, can also be used. Halide nitrogen-containing ionic liquids are commercially available or can be prepared by reacting the nitrogen-containing moiety with a suitable alkyl halide. Synthetic methods for making halide ionic liquids are described, for example, by Lee at al. [Int. J. of Hydrogen Energy, 33, p. 6031-6036, (2008)] and Wang at al. [Acta Phys.- Chim. Sin., 21(5), p.517-522 (2005)].

The feed stream indicated by numeral (5d) supplies oxygen to the reactor, either neat oxygen, oxygen-rich air stream or air. Oxygen alone is unable to act on the aforementioned pollutants to accomplish their oxidation and the increased rate of decomposition of pollutants observed when oxygen is added to the reaction vessel is therefore quite surprising. Without wishing to be bound by theory, it is believed that molecular oxygen is transformed into a reactive oxygen species in the treatment zone.

Regarding the amounts of the reagents (5a, 5b, 5c and 5d) required for the treatment, as pointed out above, the invention requires hydrogen peroxide to act in an alkaline solution. Alkali hydroxide is added to the polluted aqueous stream to reach a concentration of not less than 5 mM, e.g., from 5 mM to 10 M (for example, from 50 mM to 5 M) depending on the type and concentration of the pollutant. The relative amounts of the alkali hydroxide and hydrogen peroxide are adjusted such that the molar ratio between the hydrogen peroxide and the hydroxide ion is preferably at least 0.5:1, more preferably at least 1:1, e.g., in the range of 1.2:1 to 2:1, with a ratio of 1.4:1 to 1.8:1, and especially about 1.5:1, being most preferred. The volumetric ratio between the water to be treated and organic additive is from 2000:1 to 100:1. The molar ratio H₂O₂:O₂ is from 1:1 to 1:100, e.g., preferably from 1:2 to 1:10.

Turning now to the order and rate of addition of the feed streams 5a, 5b, 5c and 5d to the reactor (3), said streams may be added either simultaneously or successively. Simultaneous feeding of separate streams is also meant to include the feeding of alkali hydroxide and hydrogen peroxide streams which partially overlap in time. Premixing of alkali hydroxide and hydrogen peroxide, followed by the feed of a combined stream of both reagents to the reaction vessel is also possible, provided that the premixing of the alkali hydroxide and hydrogen peroxide is carried out under conditions allowing the instantaneous addition of the so-formed aqueous mixture into the organic solution, preferably such that the time which elapses between the aqueous mixture formation and its being fed will be less than about 5 seconds. This could be accomplished with the aid of a suitably configured jet mixer. However, it is most preferred to bring together the alkali hydroxide and hydrogen peroxide in an alkaline aqueous environment. For this reason, the addition of the hydrogen peroxide succeeds the addition of the base. Thus, one preferred order of reagents addition consists of first adding the alkali hydroxide to the polluted water, followed by the addition the organic additive, with the aqueous hydrogen peroxide and oxygen being the last added reagents. There are no special requirements placed on the rate of addition of the alkali hydroxide and the organic additive. The addition of hydrogen peroxide solution is carried out gradually e.g., in a dropwise manner, over a period of time, hereinafter referred to as the ‘addition time’. For example, a flow rate from 0.01 to 0.2 liter per hour may be employed to feed the H₂O₂ solution to the reactor. Because of the slow addition requirement placed on the H₂O₂ feeding, on an industrial scale the addition time may be not less than five minutes, e.g., from 10 to 120 minutes.

Oxygen is fed either concurrently with, or subsequent to, hydrogen peroxide addition to the reactor. For example, oxygen gas is caused to flow into the reactor at a flow rate ranging from 0.06 to 1 liter per hour. Bubbling of oxygen through the polluted water is not mandatory, because dissolved oxygen levels, e.g., of not less than 8 mg/L, may suffice to advance the degradation of the contaminant. In general, however, the oxidation of the pollutant could benefit from the addition of oxygen, which was shown to shorten the time needed to achieve full degradation of the pollutant.

In a batch mode of operation, after the addition of the peroxide source (e.g., hydrogen peroxide solution) and oxygen gas has been completed, the mixture is generally stirred for a period of time hereinafter referred to as the ‘hold time’. The hold time according to the invention is generally between 10 and 60 minutes. Stirring velocity is generally from 200 to 1000 rpm.

Downstream to reactor (3) there are two separation units (7) and (9) positioned in series. The reaction mass is discharged from the outlet of reactor (3) and pumped (6) to the first separation unit (7), where the reaction mixture is separated into aqueous and organic phases. The latter maybe recycled, to enable reuse of the organic additive. The aqueous solution that exits unit (7) is transferred by pump (8) to the second separation unit (9) where the inorganic salt reaction products (e.g., Na₂CO₃ 12) are separated and the treated water stream (11) is withdrawn from unit (9) by means of pump (10). The invention can achieve more than 95% conversion of the contaminant, and even more than 97 or 99% conversion.

The polluted water stream, indicated by numeral 1 in FIG. 1, may be a wastewater stream (such as an industrial effluent, a hospital effluent, an effluent produced in municipal wastewater treatment plants), groundwater and surface water. The pollutant to be removed may be in a solubilized form, i.e., a solute dissolved in the water, or water insoluble/immiscible pollutant. It should be noted that the lower the concentration of the pollutant in the water, the more challenging is its removal. The method of the invention can target even very low pollution levels (from 1 to 10 ppm) and reduce such levels to the order of a few hundreds ppb’s (i.e., to 700 ppb or less).

One important type of pollutants that can be removed from water by the method of the invention consist of pharmaceutical compounds or leftovers. Pharmaceuticals are discharged by the manufacturers, hospitals and consumers to wastewater and can eventually be detected in many types of water bodies, such as groundwater and surface water, because municipal wastewater treatment plants do not remove pharmaceutical pollutants efficiently. Owing to their poor removal rates, many drugs are led by the effluent produced in wastewater treatment plants to groundwater etc.

One pharmaceutical that is notorious for its persistence to municipal wastewater treatment is carbamazepine, a dibenzoazepine derivative used in the treatment of epilepsy, neuropathic pain and schizophrenia, i.e., psychiatric drug:

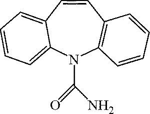 [SMILES: NC(=O)N1c2ccccc2C=Cc2ccccc21]

Data published indicates that the concentrations of carbamazepine in the influent entering wastewater treatment plants and in effluent discharged into water bodies are roughly the same. That is, carbamazepine is removed to a small extent by wastewater treatment plants [“Occurrence of pharmaceutical residues in water and treatment solutions”; Thesis: Tung Pham Thanh, Metropolia University of Applied Sciences, https://www.theseus.fi/bitstream/handle/10024/145601/Pham_Tung.pdf?sequence=1.]

Carbamazepine can serve as a benchmark in the assessment of technologies for removal of pharmaceuticals from water (e.g., surface water, groundwater, hospital effluents, industrial waste streams produced by pharmaceuticals industries). Experimental results reported below indicate that high removal rates can be achieved with the MOH⁺H₂O₂ reagent of the invention, even over a very low concentration range of the drug. For example, for the highly persistent carbamazepine, from 70 to 90% removal rates were achieved across a low pollution level of 1 to 10 ppm.

Accordingly, another aspect of the invention relates to the removal of pharmaceuticals, for example, a fused-ring pharmaceutical, with ring heteroatom(s), e.g., ring nitrogen, such as dibenzoazepine drugs, specifically carbamazepine.

The method of the invention could be integrated into the treatment programs of waste produced by pharmaceutical manufacturers and hospital effluents.

### BRIEF DESCRIPTION OF THE DRAWINGS

FIG. 1 shows an illustrative design of the process.

FIG. 2 shows spectra recorded to monitor decomposition of Rhodamine B over time, alongside a set of samples indicating the vanishment of the characteristic intense pink color of Rhodamine B.

FIG. 3 is a photo of the experimental set-up that was used in Example 9.

FIG. 4 shows conversion percentage versus time curves plotted for Experiments A and Bin Example 10.

FIG. 5 is a bar diagram showing conversion percentage of carbamazepine.

### DETAILED DESCRIPTION

### Examples

### Methods

UV-Vis spectroscopy: 1800 UV spectrophotometer, Shimadzu, Japan.

Gas chromatography - flame ionization detector (GC-FID): Famewax column, 30 m, 0.32 mm ID, 0.25 mm (Restek™ Famewax).

HPLC: LC-MS, QTOF 6520, manufactured by Agilent.

TOC: multi N/C pharma UV, TOC analyzer, manufactured by AnalytikJena.

### Examples 1 to 8

### Degradation of Organic Pollutants in Water by the Combined Action of Sodium Hydroxide and Hydrogen Peroxide in the Presence of Organic Additive

A 50 ml round bottom flask equipped with a magnetic stirrer was charged with 10 ml of water polluted with an organic compound as tabulated in Table 1. The initial concentration of the organic compound (Ci) in the water is set out in Table 1.

Sodium hydroxide in a solid form was rapidly added and dissolved, followed by addition of either a phase transfer catalyst or a surfactant. Next, hydrogen peroxide solution (30% strength) was added very slowly over an ‘addition time’. Upon complete addition of the hydrogen peroxide, the mixture was held under stirring for a period of time (‘hold time’). The amount of sodium hydroxide added (m_{NaOH}), the additive employed, the volume of H₂O₂ solution added (V_{H2O2}), the addition time of H₂O₂ and the hold time are set out in Table 1 for each experiment.

The reaction mixture was extracted with dichloromethane (10 ml). The mixture was separated into organic and aqueous phases and the organic (dichloromethane) phase was analyzed by GC-FID to measure the final concentration of remnant of organic pollutant (C_{f}) and calculate percentage of decomposition achieved. The experimental conditions and results are tabulated in Table 1.

TABLE 1

| Ex | pollutant | Cᵢ (ppm) | m_{NaOH} (g) | Additive A, B or C (ml) | V_{H202} (ml) | Addition time (min) | Hold time (min) | C_{f} (ppm) | Decom. % |
|---|---|---|---|---|---|---|---|---|---|
| 1 | Rhodamine B | 1000 | 1 | A 0.5 | 1.5 | ~1 | 60 | 2 | 99 |
| 2 | Rohdamine B | 125 | 0.1 | A 0.05 | 0.15 | ~1 | 60 | 0.16 | 99 |
| 3 | ClCH₂CH₂Cl | 850 | 0.1 | A 0.05 | 0.15 | ~1 | 60 | 0 | 100 |
| 4 | CCl₄ | 800 | 0.1 | A 0.05 | 0.15 | ~1 | 60 | 0 | 100 |
| 5 | chlorobenzene | 500 | 0.2 | B 0.1 | 0.35 | ~1 | 60 | 9 | 98 |
| 6 | toluene | 500 | 0.1 | C 0.05 | 0.15 | ~1 | 60 | 5 | 99 |
| 7 | Xylene* | 100 | 0.1 | A 0.05 | 0.15 | ~1 | 60 | 1 | 99 |
| 8 | Naphthalene | 30 | 0.5 | B 0.2 | 0.75 | ~1 | 60 | 0 | 100 |

* Xylene used in the experiments described herein consists of a mixture of the three xylene isomers.
A - Aliquat 336
B - sodium lauryl sulfate (SLS)
C - Alkanol 6112

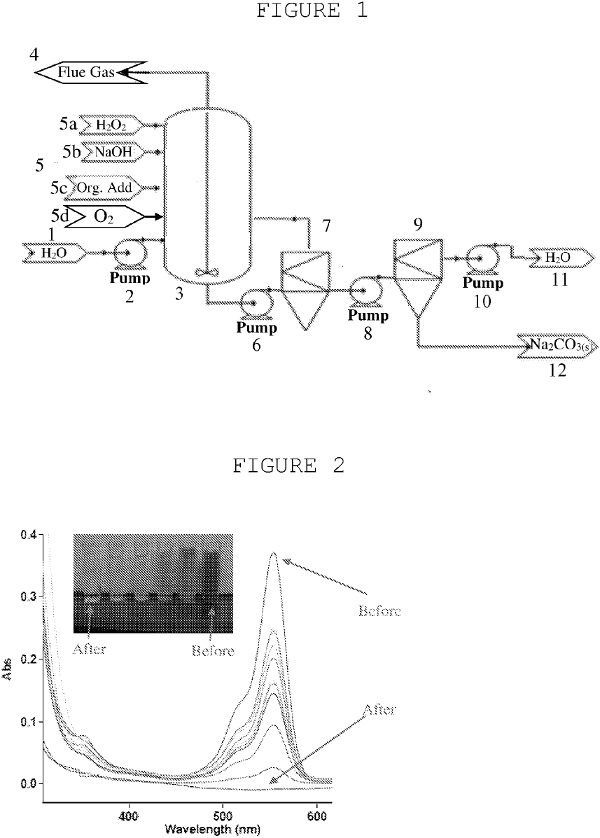

Rhodamine B (RhB) is a water-soluble chemical dye which is commonly used as a benchmark to assess the potency of oxidants to decompose organic pollutants in aqueous solution and measure the rate of degradation. De-colorization of RhB solution, that is, the disappearance of the characteristic intense pink color, is readily visible as the decomposition of the dye advances under the action of the tested oxidant and the oxidation reaction can be monitored with UV-Vis spectroscopy. FIG. 2 shows the spectra recorded to monitor RhB decomposition over time (note the characteristic strong absorption peak at ~560 nm which gradually vanishes). A photograph of a set sample solutions exhibiting the color change, from intense pink to colorless solution, is also provided. Decolorization of 1000 ppm and 125 ppm RhB solutions was completed within eleven minutes and two minutes, respectively, i.e., well before the end of the experiments.

### Example 9

### Inactivation of Bacteria in Water by the Combined Action of Sodium Hydroxide and Hydrogen Peroxide and Oxidation of Carbon Content of the Bacteria

The procedure described in the previous set of Examples was repeated, this time using water polluted with E-coli. The experimental conditions and results are set out in Table 2. The organic additive used was anionic surfactant sodium lauryl sulfate (SLS) .

TABLE 2

| Ex | pollutant | Cᵢ (CFU/ml) | mNaOH (g) | Additive (ml) | V_{H2O2} (ml) | Addition time (min) | Hold time (min) | C_{f} (CFU/ml) | Decom. % |
|---|---|---|---|---|---|---|---|---|---|
| 9 | E-coli | 3*10⁷ | 0.01 | 0.1 | 0.015 | ~1 | 60 | 0 | 100 |

The data in Table 2 demonstrates the bactericidal effect generated by the combination of hydrogen peroxide and alkaline hydroxide with the aid of sodium lauryl sulfate.

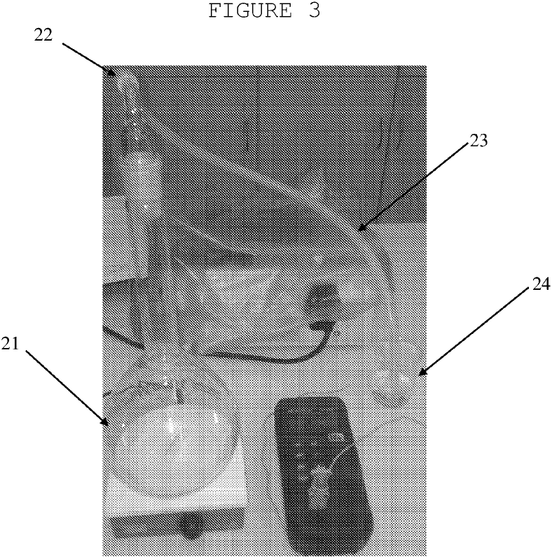

To show the decomposing activity of the H₂O₂⁺NaOH combination, the experimental set-up (20) shown in FIG. 3 was used. A round single-necked flask which contains the reaction mixture (21) is provided with an adapter (22) fitted with a pipe (23) to deliver gaseous reaction products into a beaker (24) charged with barium chloride solution. The water used in the experiment is devoid of carbonate and the set-up is designed to collect carbon dioxide which may be generated by the reaction due to partial or complete oxidation of the carbon content of the bacteria. Formation of carbon dioxide could manifest itself in two ways:
(i) generation of water soluble sodium carbonate in flask (21), as a result of CO₂ conversion to carbonate by the action of radicals such as superoxide produced on addition of hydrogen peroxide to alkaline environment; and
(ii) precipitation of the water insoluble barium carbonate salt in beaker (24), which takes place when carbon dioxide evolving in the reaction mixture escapes from flask (21), flows through pipe (23) and dissolves in the barium chloride solution (24).

In a typical experiment, the barium chloride solution retained its clarity and no cloudiness indicative of barium carbonate precipitation was observed in beaker (24). But on drying the reaction mixture (21) in an oven at 200° C. to completely remove the water, a solid was collected which was found to consist essentially of sodium carbonate Na₂CO₃, as determined by X-ray powder diffraction analysis.

### Example 10

### Degradation of an Aromatic Pollutant by the Combined Action of Sodium Hydroxide and Hydrogen Peroxide in the Presence of Organic Additive and Added Oxygen

Experiment A: In the reference experiment, a 50 ml round bottom flask equipped with a magnetic stirrer was charged with 10 ml of water polluted with 100 ppm of xylene. Sodium hydroxide (0.5 g) was rapidly added followed by addition of 0.02 ml of a phase transfer catalyst (Aliquat 336) Next, 1 ml of aqueous hydrogen peroxide (30% solution) was introduced over 5 minutes. After the addition of hydrogen peroxide solution has been completed, the mixture was held under stirring for ten minutes.

Experiment B: To assess the effect of added oxygen, the procedure set forth above was repeated but after the addition of hydrogen peroxide, pure oxygen was bubbled to the system at a flow rate of 1 ml/min over 30 minutes. Upon completion of O₂ addition, the mixture was stirred for ten minutes.

For each experiment, samples (0.5 ml) were taken from the reaction mixture at intervals of one minute during the ten minutes hold time and the concentration of remnant xylene was measured by GC-FID. The final reaction mixture was extracted with dichloromethane (10 ml) and analyzed by GC-FID as previously described. Conversion percentage versus time curves are plotted in FIG. 4 for Experiments A and B. The results indicate the enhancement of conversion rate achieved with the aid of added oxygen, reaching complete oxidation of the pollutant after a hold time period of about six minutes (compared to ten minutes hold time needed in Experiment A in the absence of added oxygen).

### Example 11

### Degradation of a Pharmaceutical by the Combined Action of Sodium Hydroxide and Hydrogen Peroxide in the Presence of Phase Transfer Catalyst and Added Oxygen

A series of experiments was carried out to examine the decomposition of carbamazepine by the method of the invention.

A 50 ml round bottom flask equipped with a magnetic stirrer was charged with 10 ml of water polluted with 1-100 ppm of carbamazepine (concentrations of 1, 10 and 100 ppm were examined). Sodium hydroxide (0.5 g) was rapidly added followed by addition of 0.02 ml of a phase transfer catalyst (Aliquat 336) Next, 1 ml of aqueous hydrogen peroxide (30% solution) was introduced over 5 minutes. After the addition of hydrogen peroxide, the mixture was held under stirring and pure oxygen was bubbled to the system at a flow rate of 0.5 ml/min over 10 minutes. For each experiment, at the end of the process the final reaction mixture was extracted with 5 ml of Acetone: hexane solution (1:1) and carbamazepine remnant concentration was measured by LC-MS, QTOF 6520, manufactured by Agilent.

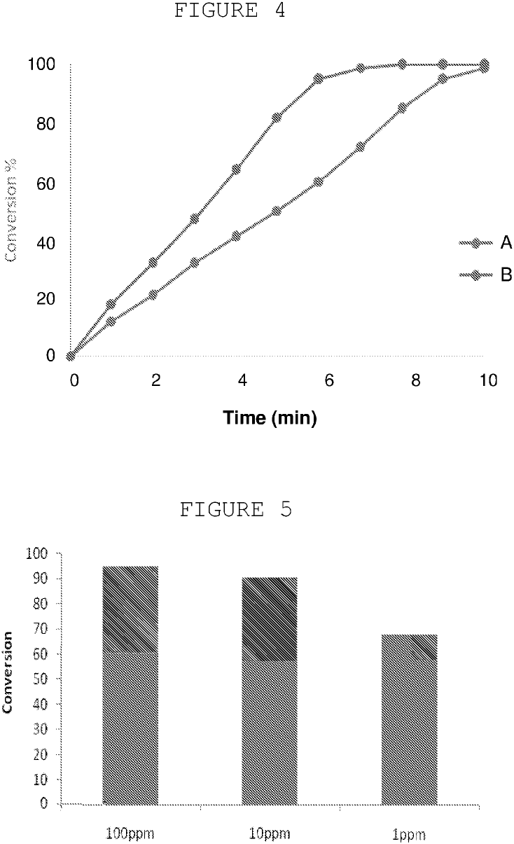

The results are shown by a bar diagram appended as FIG. 5. It is seen that very high decomposition rates of the drug were achieved (>90% conversion) for the 10 and 100 ppm concentrations. The Elimination of pollutants present at very low concentrations (1 ppm) is difficult to achieve but it is seen that surprisingly high conversion rate (~70%) was measured also for the 1 ppm carbamazepine.

### Example 12

### Purification of Groundwater by the Combined Action of Sodium Hydroxide and Hydrogen Peroxide in the Presence of Phase Transfer Catalyst and Added Oxygen

The goal of the experiment was to test the NaOH+H₂O₂ action in the treatment of a sample of contaminated groundwater (by organic C₆-C₄₀ pollutants) from the Netherlands, Rotterdam area. The initial contamination level was 315 ppm, measured by multi N/C pharma UV, TOC analyzer, manufactured by AnalytikJena.

A 50 ml round bottom flask equipped with a magnetic stirrer was charged with 10 ml of groundwater polluted with organic contaminants. Sodium hydroxide (0.4 g) was rapidly added followed by addition of 0.02 ml of a phase transfer catalyst (Aliquat 336). Next, 0.8 ml of aqueous hydrogen peroxide (30% solution) was introduced over 3 minutes. After the addition of hydrogen peroxide, the mixture was held under stirring and pure oxygen was bubbled to the system at a flow rate of 0.5 ml/min over 30 minutes.

The treatment reduced pollution level in the water to 2.6 ppm measured the TOC analyzer, i.e., 99% conversion rate.

While the present disclosure has been illustrated and described with respect to a particular embodiment thereof, it should be appreciated by those of ordinary skill in the art that various modifications to this disclosure may be made without departing from the spirit and scope of the present disclosure.

1. A method of purifying water polluted with one or more organic compounds, comprising adding a peroxide source to the polluted water in an alkaline environment in the presence of at least one additive selected from the group consisting of surfactants and phase transfer catalysts, optionally feeding oxygen or an oxygen-releasing substance to the water, separating the so-formed reaction mixture into aqueous and organic phases, to recover a treated water stream and an organic stream, wherein the purification of the water by the removal of organic pollutants is achieved at ambient temperature.

2. The method according to claim 1, comprising adding alkali hydroxide to the water to create an alkaline environment and gradually feeding hydrogen peroxide to the water.

3. The method according to claim 2, wherein the surfactant is an anionic surfactant or nonionic surfactant and the phase transfer catalyst is a quaternary ammonium salt consisting of a cation of the formula N⁺R₁R₂R₃R₄, wherein each of R₁, R₂, R₃ and R₄ is independently Cl-C18 alkyl group, and a counter anion.

4. The method according to claim 1, wherein the organic pollutants to be removed are devoid of nitrogen and phosphorus atoms.

5. The method according to claim 4, wherein the organic pollutants comprise one or more aromatic compounds selected from the group consisting of benzene, alkyl-substituted benzene, polycyclic aromatic hydrocarbons consisting of two or more aromatic rings fused together, and halogenated aromatic rings.

6. The method according to claim 4, wherein the organic pollutant is a halogen-substituted aliphatic hydrocarbon.

7. The method according to claim 1, wherein the organic pollutants to be removed comprise one or more pharmaceuticals.

8. The method according to claim 7, wherein at least one pharmaceutical is a fused-ring compound.

9. The method according to claim 8, wherein at least one pharmaceutical is dibenzoazepine drug.

10. The method according to claim 9, wherein the dibenzoazepine drug is carbamazepine.

11. The method according to claim 1, wherein the polluted water is groundwater.

12. The method according to claim 1, further comprising bubbling neat oxygen, oxygen-rich air or air through the polluted water.

13. A method of disinfecting water polluted with microbial pollutants, comprising adding a peroxide source to the polluted water in an alkaline environment in the presence of at least one additive selected from the group consisting of surfactants and phase transfer catalysts, optionally feeding oxygen or oxygen-releasing substance to the water, separating the reaction mass into aqueous and organic phases, to recover treated water stream and a recyclable organic stream.

14. The method according to claim 12, comprising adding alkali hydroxide to the water to create an alkaline environment and gradually feeding hydrogen peroxide to the water.

15. The method according to claim 13, wherein the surfactant is an anionic surfactant.

16. The method according to claim 3, wherein the surfactant is an anionic surfactant or nonionic surfactant and the phase transfer catalyst is a quaternary ammonium salt consisting of a cation of the formula N⁺R₁R₂R₃R₄, wherein each of R₁, R₂, R₃ and R₄ is independently Cl-C18 alkyl group, and a counter anion.

17. The method according to claim 2, wherein the organic pollutants to be removed are devoid of nitrogen and phosphorus atoms.

18. The method according to claim 3, wherein the organic pollutants to be removed are devoid of nitrogen and phosphorus atoms.

19. The method according to claim 2, wherein the organic pollutants to be removed comprise one or more pharmaceuticals.

20. The method according to claim 3, wherein the organic pollutants to be removed comprise one or more pharmaceuticals.
